(19) United States
(12) Patent Application Publication
(10) Pub. No.: US 2019/0204486 A1
(43) Pub. Date: Jul. 4, 2019

(54) OPTICAL FILM WITH CONDUCTIVE FUNCTION

(71) Applicant: imat corporation, Hsinchu City (TW)

(72) Inventors: Tsai-An Yu, Hsinchu County (TW); Da-Ren Chiou, Taoyuan City (TW); Shih-Ming Hung, Hsinchu City (TW); Kuo-Chen Wu, Hsinchu City (TW); Yi-Chien Chen, Hsinchu County (TW); Hsiu-Yun Hsu, Hsinchu County (TW)

(73) Assignee: imat corporation, Hsinchu City (TW)

(21) Appl. No.: 16/030,838

(22) Filed: Jul. 9, 2018

(30) Foreign Application Priority Data
Dec. 28, 2017 (TW) 106146342

(51) Int. Cl. G02B 5/30

(52) U.S. Cl. CPC G02B 5/3016; G02F 1/13338

(57) ABSTRACT

An optical film with a conductive function is provided. The optical film with the conductive function includes a liquid crystal optical compensation film and a conductive layer. The conductive layer is disposed on the liquid crystal optical compensation film.

### CROSS-REFERENCE TO RELATED APPLICATION

This application claims the priority benefit of Taiwan application serial no. 106146342, filed on Dec. 28, 2017. The entirety of the above-mentioned patent application is hereby incorporated by reference herein and made a part of this specification.

### BACKGROUND

### Technical Field

The disclosure relates to an optical film, and more particularly to an optical film with a conductive function.

### Related Art

In the modern information society, people's reliance on electronic products is increasing day by day. To achieve more convenience, more compact volume and more user-friendly designs, touch panels have been introduced to replace conventional keyboards or mice to serve as input devices of many information products. Among them, a touch display having both touch and display functions has become one of the most popular products at present. With the advances in technology, electronic products are gradually becoming lighter and slimmer. However, the size reduction of the existing touch displays has almost reached the limit. Therefore, to develop an optical compensating film which has a conductive function is one of objectives that people in this field pursue.

### SUMMARY

The disclosure provides an optical film with a conductive function, and application of the optical film in a touch display may reduce an overall thickness of the touch display.

The optical film with a conductive function according to the disclosure includes a liquid crystal optical compensation film and a conductive layer. The conductive layer is disposed on the liquid crystal optical compensation film.

In one embodiment of the disclosure, the liquid crystal optical compensation film is a monomeric liquid crystal optical compensation film.

In one embodiment of the disclosure, the liquid crystal optical compensation film includes a liquid crystal broadband phase retardation film, a liquid crystal positive C-plate retardation film, a liquid crystal negative C-plate retardation film, a liquid crystal A-plate retardation film, a liquid crystal O-plate retardation film, or a liquid crystal bi-axial retardation film.

In one embodiment of the disclosure, the liquid crystal optical compensation film has a thickness of 1 μm to 30 μm.

In one embodiment of the disclosure, a material of the conductive layer includes a metal material, a metal oxide conductive material, a carbonaceous material, a nanomaterial, or an organic conductive material.

In one embodiment of the disclosure, the metal material includes aluminum, copper, molybdenum, silver, gold, platinum, chromium, palladium, rhodium, or an alloy thereof.

In one embodiment of the disclosure, the metal oxide conductive material includes chromium oxide (Cr₂O₃), tin oxide (TO), magnesium hydroxide (Mg(OH)₂), indium-tin oxide (ITO), indium-gallium-zinc oxide (IGZO), zinc oxide (ZnO), tin dioxide (SnO₂), indium oxide (In₂O₃), indium-zinc oxide (IZO), aluminum-zinc oxide (AZO), gallium-zinc oxide (GZO), aluminum-tin oxide (ATO), cadmium oxide (CdO), cadmium-indium oxide (CdIn₂O₄), cadmium-tin oxide (Cd₂SnO₄), or zinc-tin oxide (Zn₂SnO₄).

In one embodiment of the disclosure, the carbonaceous material includes carbon black, graphite, acetylene black, graphene, carbon nanotubes, or buckyballs.

In one embodiment of the disclosure, the nanomaterial includes silver nanoparticles, silver nanowires, nano-silver ink, nano-silver salt, copper nanoparticles, or indium-tin oxide nanoparticles.

In one embodiment of the disclosure, the organic conductive material includes polythiophene, polyaniline (PANi), polypyrrole, poly(p-phenylene), polyphenylene vinylene, polyacetylene or a derivative thereof.

Based on the above, the optical film with the conductive function according to the disclosure includes the liquid crystal optical compensation film and the conductive layer disposed on the liquid crystal optical compensation film. Thus, compared to conventional touch displays, a touch display in which the optical film with the conductive function according to the disclosure is applied may be reduced in overall thickness.

To make the above features and advantages of the disclosure more comprehensible, several embodiments accompanied with drawings are described in detail as follows.

### BRIEF DESCRIPTION OF THE DRAWINGS

FIG. 1 is a schematic cross-sectional view of an optical film with a conductive function according to one embodiment of the disclosure.

FIG. 2 illustrates a curve diagram showing chromatography results obtained from Experiment 1.

FIG. 3A and FIG. 3B illustrate mass spectra obtained from Experiment 2.

FIG. 4 illustrates a curve diagram showing a relationship between wavelength and retardation value obtained from Experiment 3.

FIG. 5 illustrates a curve diagram showing a relationship between wavelength and retardation value obtained from Experiment 4.

FIG. 6 illustrates a curve diagram showing a relationship between wavelength and transmittance obtained from Experiment 5.

FIG. 7 illustrates a curve diagram showing a relationship between wavelength and transmittance obtained from Experiment 6.

### DETAILED DESCRIPTION OF DISCLOSED EMBODIMENTS

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with any numerical value and a smaller numerical range thereof in the specification.

To provide an optical film for a touch display to enable the touch display to have a reduced thickness, the disclosure proposes an optical film with a conductive function, capable of attaining the above-mentioned advantage. In the following, one embodiment is described as examples according to which the disclosure can be surely implemented.

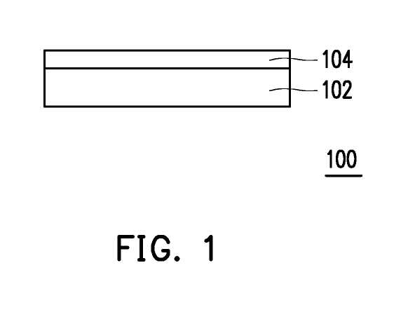

FIG. 1 is a schematic cross-sectional view of an optical film with a conductive function according to one embodiment of the disclosure. Referring to FIG. 1, an optical film 100 includes a liquid crystal optical compensation film 102 and a conductive layer 104.

In the present embodiment, the liquid crystal optical compensation film 102 is a monomeric liquid crystal optical compensation film. In detail, in one embodiment, the liquid crystal optical compensation film 102 may have a reticular structure formed by subjecting a liquid crystal monomer to crosslinking reaction.

From another point of view, examples of the liquid crystal optical compensation film 102 may include (but is not limited to): a liquid crystal broadband phase retardation film, a liquid crystal positive C-plate retardation film, a liquid crystal negative C-plate retardation film, a liquid crystal A-plate retardation film, a liquid crystal O-plate retardation film, a liquid crystal biaxial retardation film, or a combination thereof. In one embodiment, in the case where the liquid crystal optical compensation film 102 is implemented as a liquid crystal broadband phase retardation film, the liquid crystal broadband phase retardation film may include two phase retardation films stacked with each other, wherein one of the two phase retardation films has an in-plane phase difference Ro of 70 nm to 130 nm, the other of the two phase retardation films has an in-plane phase difference Ro of 140 nm to 260 nm, and an included angle between the optical axes of the two phase retardation films is 35° to 70°. In addition, materials of the two phase retardation films may respectively include a discotic liquid crystal, a rod-like liquid crystal, or a rod-like liquid crystal doped with chiral molecules, wherein the chiral molecules are added by 0.01% to 3% of the solid content.

In addition, in the present embodiment, the liquid crystal optical compensation film 102 has a thickness of, for example, 1 μm to 30 μm.

In the present embodiment, the conductive layer 104 is disposed on the liquid crystal optical compensation film 102. In detail, the conductive layer 104 is in direct contact with the liquid crystal optical compensation film 102. That is, in the present embodiment, there is no other film layer disposed between the conductive layer 104 and the liquid crystal optical compensation film 102.

The material of the conductive layer 104 may include (but is not limited to): a metal material, a metal oxide conductive material, a carbonaceous material, a nanomaterial, or an organic conductive material. The metal material may include (but is not limited to): aluminum, copper, molybdenum, silver, gold, platinum, chromium, palladium, rhodium, or an alloy thereof. In the case where the material of the conductive layer 104 is a metal material, the conductive layer 104 may be a metal mesh made of the above-listed metal materials. The metal oxide conductive material may include (but is not limited to): chromium oxide (Cr₂O₃), tin oxide (TO), magnesium hydroxide (Mg(OH)₂), indium-tin oxide (ITO), indium-gallium-zinc oxide (IGZO), zinc oxide (ZnO), tin dioxide (SnO₂), indium oxide (In₂O₃), indium-zinc oxide (IZO), aluminum-zinc oxide (AZO), gallium-zinc oxide (GZO), aluminum-tin oxide (ATO), cadmium oxide (CdO), cadmium-indium oxide (CdIn₂O₄), cadmium-tin oxide (Cd₂SnO₄), or zinc-tin oxide (Zn₂SnO₄). The carbonaceous material may include (but is not limited to): carbon black, graphite, acetylene black, graphene, carbon nanotubes, buckyballs and so on. The nanomaterial may include (but is not limited to): silver nanoparticles, silver nanowires, nano-silver ink, nano-silver salt, copper nanoparticles, indium-tin oxide nanoparticles and so on. The organic conductive material may include (but is not limited to): polythiophene, polyaniline (PANi), polypyrrole, poly(p-phenylene), polyphenylene vinylene, polyacetylene or a derivative thereof. In addition, in the present embodiment, the conductive layer 104 has a thickness of, for example, 1 μm to 20 μm.

It is worth mentioning that, the optical film 100 may be applied to a touch display implemented by integrating a touch panel with a display panel, wherein the display panel is, for example, a liquid crystal display (LCD) panel or an organic light-emitting diode (OLED) panel. In detail, in the case where the optical film 100 is applied to a touch display, the conductive layer 104 may serve as a touch electrode, and the liquid crystal optical compensation film 102 may serve as a substrate for carrying the conductive layer 104. That is, in the present embodiment, the conductive layer 104 may be a patterned conductive layer; the liquid crystal optical compensation film 102 not only provides an optical compensation function but also serves as a substrate for the conductive layer 104.

It is worth noting that, the optical film 100 includes the liquid crystal optical compensation film 102 and the conductive layer 104 stacked in sequence, and thus compared to conventional touch displays, the touch display applying the optical film 100 has a reduced thickness. The reason is that, compared to conventional touch displays, in the touch display applying the optical film 100, a substrate located on one side for carrying a touch electrode and an adhesion layer for sticking the substrate to the touch electrode are omitted and replaced with one liquid crystal optical compensation film 102, and the conductive layer 104 disposed on the liquid crystal optical compensation film 102 serves as the touch electrode.

In addition, as mentioned previously, the conductive layer 104 disposed on the liquid crystal optical compensation film 102 may be a patterned conductive layer. Therefore, as verified through experiments as described below, the liquid crystal optical compensation film 102 is neither damaged nor changed in optical characteristics after undergoing a patterning process, so that the optical film 100 has good structural stability, which thus ensures product quality when the optical film 100 is applied to a touch display.

### Experiment 1

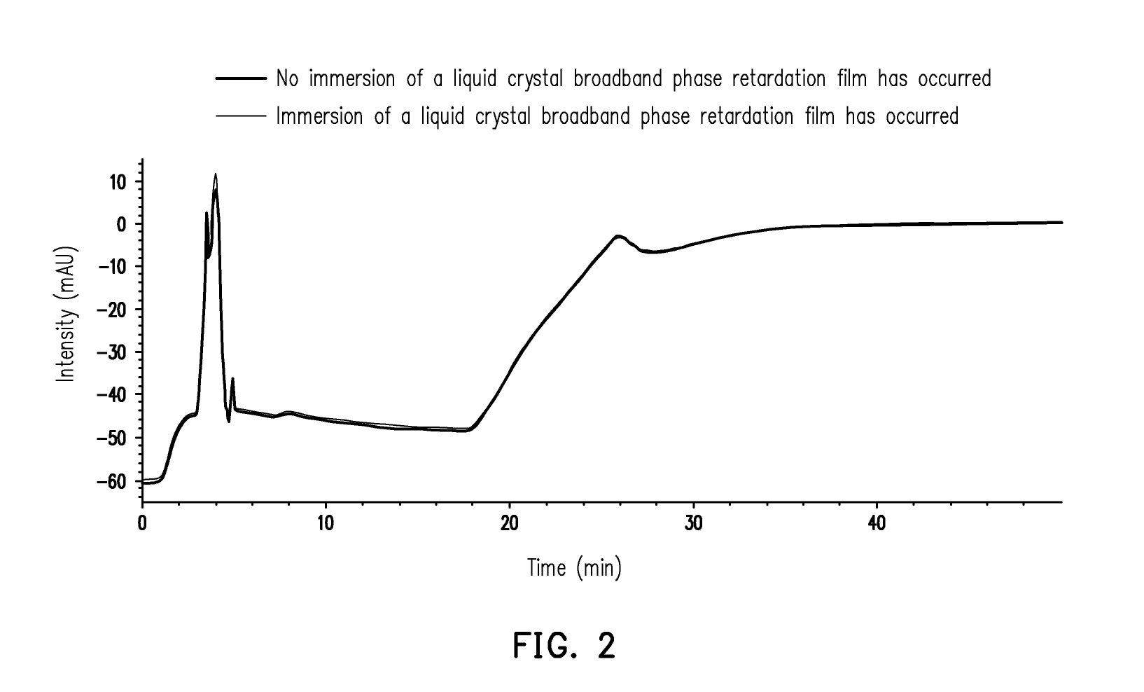

A liquid crystal broadband phase retardation film including a liquid crystal phase retardation film, UV gel and a liquid crystal phase retardation film stacked in sequence (made by imat corporation, having a thickness of 10 μM, and hereinafter simply referred to as “liquid crystal broadband phase retardation film”) was disposed on a polyethylene terephthalate (PET) substrate. Then, the aforesaid stack layer was immersed in aluminum acid at 50° C. and stood still for 15 minutes. Next, the aforesaid aluminum acid and an aluminum acid in which no immersion of the aforesaid stack layer had ever occurred were respectively analyzed by high-performance liquid chromatography (HPLC). The chromatography results obtained from Experiment 1 were as shown in FIG. 2.

It is known from FIG. 2 that, no pollution signal appeared in the chromatography result of the aluminum acid in which the liquid crystal broadband phase retardation film was immersed. This means that the liquid crystal optical compensation film in the optical film of the disclosure is not damaged even after undergoing a patterning process.

### Experiment 2

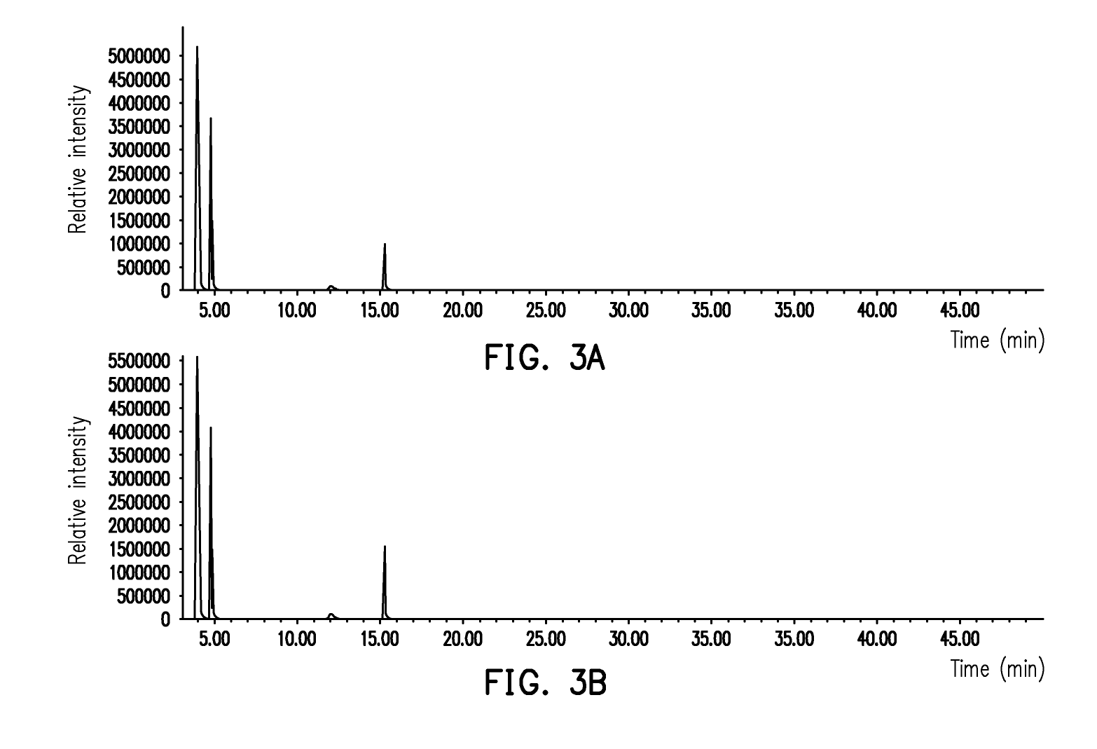

A liquid crystal broadband phase retardation film was disposed on a PET substrate. Then, the aforesaid stack layer was immersed in a photoresist stripper (5% KOH aqueous solution) at 60° C. and stood still for 15 minutes. Next, the aforesaid photoresist stripper and a photoresist stripper in which no immersion of the aforesaid stack layer had ever occurred were respectively analyzed by gas chromatography-mass spectrometry (GC-MS). The analysis results obtained from Experiment 2 were as shown in FIG. 3A and FIG. 3B, wherein the analysis result of the photoresist stripper in which no immersion of the liquid crystal broadband phase retardation film had ever occurred was as shown in FIG. 3A, and the analysis result of the photoresist stripper in which the liquid crystal broadband phase retardation film was immersed was as shown in FIG. 3B.

It is known from FIG. 3A and FIG. 3B that, no pollution signal appeared in the mass spectrogram of the photoresist stripper in which the liquid crystal broadband phase retardation film was immersed. This means that the liquid crystal optical compensation film in the optical film of the disclosure is not damaged even after undergoing a patterning process.

### Experiment 3

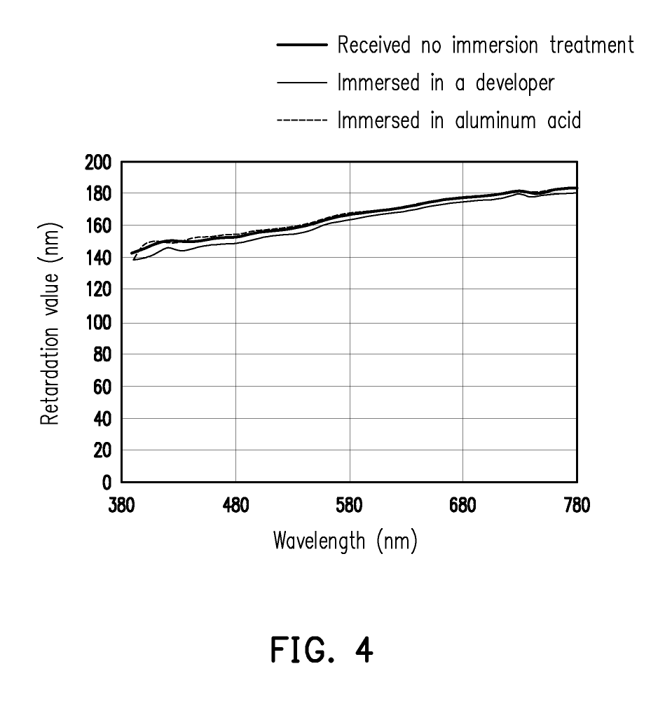

A liquid crystal broadband phase retardation film immersed in aluminum acid at 50° C. for 15 minutes, a liquid crystal broadband phase retardation film immersed in a developer (1% K₂CO₃ aqueous solution) at 55° C. for 2 minutes, and a liquid crystal broadband phase retardation film which had received no immersion treatment were respectively measured for retardation value (nm) using a phase difference meter (made by Axometrics, model: Axoscan), wherein the measurement conditions included causing light having a wavelength of 400 nm to 780 nm to be incident along a normal direction of the liquid crystal broadband phase retardation film. The measurement results obtained from Experiment 3 were as shown in FIG. 4.

It is known from FIG. 4 that, compared to the liquid crystal broadband phase retardation film which had received no immersion treatment, neither the liquid crystal broadband phase retardation film immersed in aluminum acid nor the liquid crystal broadband phase retardation film immersed in the developer exhibited a notable shift in retardation value. This means that, optical characteristics of the liquid crystal optical compensation film in the optical film of the disclosure do not change even after a patterning process.

### Experiment 4

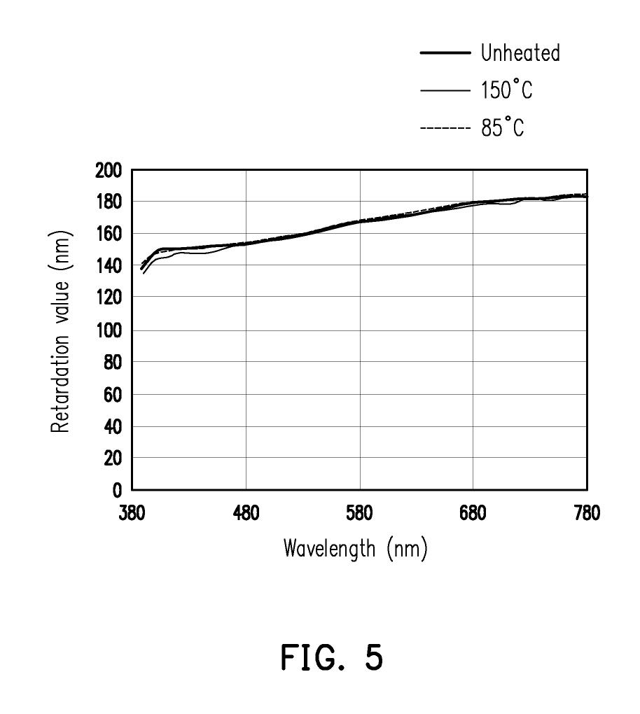

A liquid crystal broadband phase retardation film heated at 85° C. for 60 minutes, a liquid crystal broadband phase retardation film heated at 150° C. for 60 minutes, and a liquid crystal broadband phase retardation film which had received no heating treatment were respectively measured for retardation value (nm) using a phase difference meter (made by Axometrics, model: Axoscan), wherein the measurement conditions included causing light having a wavelength of 400 nm to 780 nm to be incident along the normal direction of the liquid crystal broadband phase retardation film. The measurement results obtained from Experiment 4 were as shown in FIG. 5.

It is known from FIG. 5 that, compared to the liquid crystal broadband phase retardation film which had received no heating treatment, neither the liquid crystal broadband phase retardation film heated at 85° C. nor the liquid crystal broadband phase retardation film heated at 150° C. exhibited a notable shift in retardation value. This means that, optical characteristics of the liquid crystal optical compensation film in the optical film of the disclosure do not change even after a patterning process.

### Experiment 5

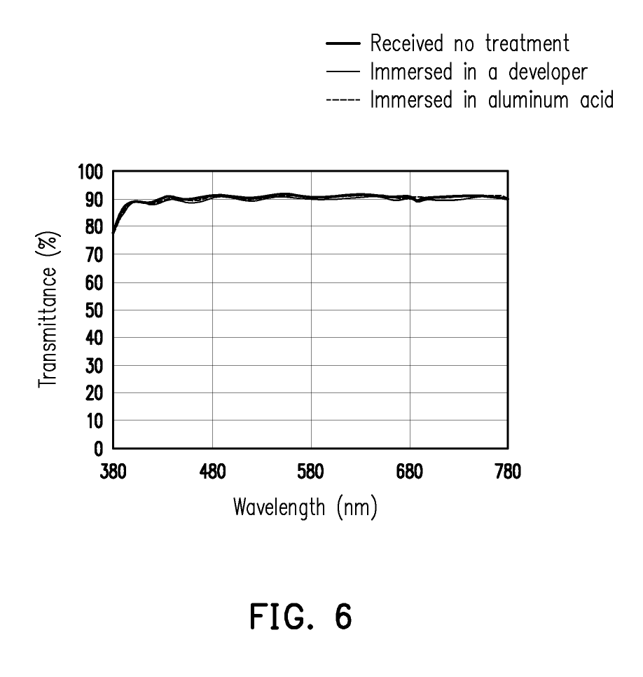

A liquid crystal broadband phase retardation film immersed in aluminum acid at 50° C. for 15 minutes, a liquid crystal broadband phase retardation film immersed in a developer (1% K₂CO₃ aqueous solution) at 55° C. for 2 minutes, and a liquid crystal broadband phase retardation film which had received no treatment were respectively measured for transmittance (%) using a UV-VIS spectrometer (made by Hitachi, model: U4100), wherein the measurement conditions included causing light having a wavelength of 380 nm to 780 nm to be incident along the normal direction of the liquid crystal broadband phase retardation film. The measurement results obtained from Experiment 5 were as shown in FIG. 6.

It is known from FIG. 6 that, compared to the liquid crystal broadband phase retardation film which had received no treatment, neither the liquid crystal broadband phase retardation film immersed in aluminum acid nor the liquid crystal broadband phase retardation film immersed in the developer exhibited a change in transmittance. This means that, optical characteristics of the liquid crystal optical compensation film in the optical film of the disclosure do not change even after a patterning process.

### Experiment 6

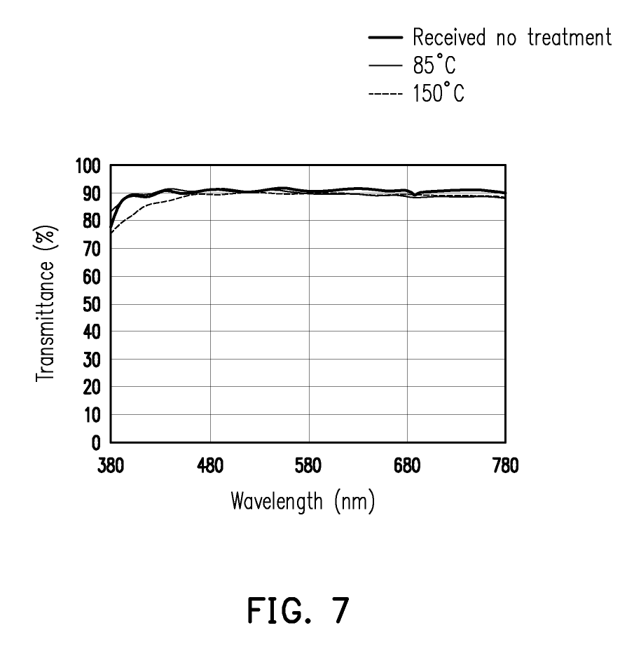

A liquid crystal broadband phase retardation film heated at 85° C. for 1 hour, a liquid crystal broadband phase retardation film heated at 150° C. for 1 hour, and a liquid crystal broadband phase retardation film which had received no treatment were respectively measured for transmittance (%) using a UV-VIS spectrometer (made by Hitachi, model: U4100), wherein the measurement conditions included causing light having a wavelength of 380 nm to 780 nm to be incident along the normal direction of the liquid crystal broadband phase retardation film. The measurement results obtained from Experiment 6 were as shown in FIG. 7.

It is known from FIG. 7 that, compared to the liquid crystal broadband phase retardation film which had received no treatment, neither the liquid crystal broadband phase retardation film heated at 85° C. nor the liquid crystal broadband phase retardation film heated at 150° C. exhibited a notable change in transmittance. This means that, optical characteristics of the liquid crystal optical compensation film in the optical film of the disclosure do not change even after a patterning process.

To sum up, the optical film with the conductive function according to the disclosure includes the liquid crystal optical compensation film and the conductive layer disposed on the liquid crystal optical compensation film. Thus, compared to conventional touch displays, in a touch display applying the optical film with the conductive function according to the disclosure, a substrate located on one side for carrying a touch electrode and an adhesion layer for sticking the substrate to the touch electrode may be omitted. Therefore, an advantage of reducing the overall thickness of the touch display is achieved.

Although the disclosure has been described with reference to the above embodiments, it will be apparent to one of ordinary skill in the art that modifications to the described embodiments may be made without departing from the spirit of the disclosure. Accordingly, the scope of the disclosure will be defined by the attached claims and not by the above detailed descriptions.

What is claimed is:

1. An optical film with a conductive function, the optical film comprising:
a liquid crystal optical compensation film; and
a conductive layer disposed on the liquid crystal optical compensation film.

2. The optical film with a conductive function according to claim 1, wherein the liquid crystal optical compensation film is a monomeric liquid crystal optical compensation film.

3. The optical film according to claim 1, wherein the liquid crystal optical compensation film comprises a liquid crystal broadband phase retardation film, a liquid crystal positive C-plate retardation film, a liquid crystal negative C-plate retardation film, a liquid crystal A-plate retardation film, a liquid crystal O-plate retardation film, or a liquid crystal biaxial retardation film.

4. The optical film according to claim 1, wherein the liquid crystal optical compensation film has a thickness of 1 μm to 30 μm.

5. The optical film according to claim 1, wherein a material of the conductive layer comprises a metal material, a metal oxide conductive material, a carbonaceous material, a nanomaterial, or an organic conductive material.

6. The optical film according to claim 5, wherein the metal material comprises aluminum, copper, molybdenum, silver, gold, platinum, chromium, palladium, rhodium, or an alloy thereof.

7. The optical film according to claim 5, wherein the metal oxide conductive material comprises chromium oxide (Cr₂O₃), tin oxide (TO), magnesium hydroxide (Mg(OH)₂), indium-tin oxide (ITO), indium-gallium-zinc oxide (IGZO), zinc oxide (ZnO), tin dioxide (SnO₂), indium oxide (In₂O₃), indium-zinc oxide (IZO), aluminum-zinc oxide (AZO), gallium-zinc oxide (GZO), aluminum-tin oxide (ATO), cadmium oxide (CdO), cadmium-indium oxide (CdIn₂O₄), cadmium-tin oxide (Cd₂SnO₄), or zinc-tin oxide (Zn₂SnO₄).

8. The optical film according to claim 5, wherein the carbonaceous material comprises carbon black, graphite, acetylene black, graphene, carbon nanotubes, or buckyballs.

9. The optical film according to claim 5, wherein the nanomaterial comprises silver nanoparticles, silver nanowires, nano-silver ink, nano-silver salt, copper nanoparticles, or indium-tin oxide nanoparticles.

10. The optical film according to claim 5, wherein the organic conductive material comprises polythiophene, polyaniline (PANi), polypyrrole, poly(p-phenylene), polyphenylene vinylene, polyacetylene or a derivative thereof.

11. The optical film according to claim 1, wherein the conductive layer contacts the liquid crystal optical compensation film.
